(19) United States
(12) Patent Application Publication
(10) Pub. No.: US 2003/0142626 A1
(43) Pub. Date: Jul. 31, 2003

(54) Communication system, communication terminal, server and data transfer control program

(75) Inventors: Masaki Umayabashi, Tokyo (JP); Kazuo Takagi, Tokyo (JP); Makoto Shibutani, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/352,168

(22) Filed: Jan. 28, 2003

(30) Foreign Application Priority Data
Jan. 29, 2002 (JP) 2002-020373

(51) Int. Cl. H04J 1/16; H04J 3/14

(52) U.S. Cl. 370/236.2; 370/470

(57) ABSTRACT

In a communication system for transmitting and receiving communication frames between a plurality of communication terminals and a server, a control frame which is indicative of control information necessary for communication between the communication terminals and the server and whose size is smaller than the size of the communication frame is transferred being included in a preamble portion of each communication frame and when no communication frame to be transmitted exists, the control frame is transferred as an independent frame.

### BACKGROUNDS OF THE INVENTION

1. Field of the Invention

The present invention relates to communication between a plurality of communication terminals and a server and, more particularly, to a communication system in which a plurality of communication terminals sequentially transfer data to a server within a transmission allowed period assigned to each of the communication terminals, a communication terminal, a server and a data transfer control program thereof.

2. Description of the Related Art

With the spread of communication services of multimedia such as voice, image and the Internet, speedup and cost-down of networks are strongly demanded.

These demands emerge related not only to basic networks but also to subscriber's access networks and application of the Ethernet (R) techniques which had been so far developed as techniques for LAN to public networks, subscriber's access network, in particular, is under way.

Drawing attention as an example of application of the Ethernet (R) techniques to a subscriber's access network is one having a point-to-multipoint PON (passive optical network) structure which allows cost reduction.

FIG. 19 is a schematic diagram of an Ethernet-based PON system, which will be hereinafter referred to as an EPON (Ethernet (R)-PON) system.

An EPON system 100 includes optical network units (communication terminals) 110 to 112, an optical line termination (server) 120, a passive signal converging/separating unit 130, fibers (optical fibers) 140 to 142 and a shared fiber 145.

To the optical network units 110 to 112, client devices 150 to 152 are connected, respectively, and to the optical line termination 120, a local switch 160 is connected.

The optical network units 110 to 112 and the passive signal converging/separating unit 130 are connected to each other through the fibers 140 to 142, while the passive signal converging/separating unit 130 and the optical line termination 120 are connected to each other through the shared fiber 145.

Because of a demand for speed-up and constraints on a covering distance, a full duplex mode gigabit Ethernet (R) is often used for the fibers 140 to 142 and the shared fiber 145.

The EPON system 100 having such a structure realizes cost-down by sharing an optical interface of the optical line termination 120 by the plurality of optical network units 110 to 112.

In the following, a data transfer method of the above-described EPON system 100 will be described with reference to the drawings.

The optical network units 110 to 112 are each composed of transmission/reception units 170 and 171, a Mux unit 172, a Demux unit 173, a buffer unit 174 and a MAC (Media Access Control) frame controlling unit 175.

The optical line termination 120 is composed of transmission/reception units 180 and 181, a Mux unit 182, a Demux unit 183, a buffer unit 184 and a MAC frame controlling unit 185.

As to downstream data transfer, a variable-length frame is broadcast from the optical line termination 120 to all the optical network units 110 to 112 and the optical network units 110 to 112 receive only a self-addressed frame.

More specifically, the transmission/reception unit 181 of the optical line termination 120 transfers a frame transferred from the local switch 160 to the Mux unit 182 and the Mux unit 182 transfers the received frame to the buffer unit 184.

The buffer unit 184 temporarily stores the frame and transfers the same to the transmission/reception unit 180. Then, the transmission/reception unit 180 transfers the frame onto the shared fiber 145.

The frames transferred on the shared fiber 145 are separated by the passive signal converging/separating unit 130 and broadcast to each of the optical network units 110 to 112 through the respective fibers 140 to 142.

The transmission/reception unit 171 of each of the optical network units 110 to 112 receives the frame sent from the optical line termination 120 and accepts the frame when a hardware address (MAC address) indicated in a destination address field of the frame corresponds to an address of its own unit. When the destination address of the frame corresponds to that of other optical network unit, the unit 171 ignores and abandons the frame The transmission/reception unit 171 transfers the received frame to the Demux unit 173 and then to the transmission/reception unit 170. Furthermore, the transmission/reception unit 170 transfers the received frame to the client devices 150 to 152.

On the other hand, as to upstream data transfer, with reference to an ATM-PON system which is a representative PON system defined by ITU-TG.983.1, in order to prevent frames sent from the plurality of the optical network units 110 to 112 from colliding at the passive signal converging/separating unit 130, the optical line termination 120 assigns a frame transmission allowed period to each of the optical network units 110 to 112 to control upstream frame sending.

More specifically, the MAC frame controlling unit 185 in the optical line termination 120 assigns a frame transmission allowed period to each of the optical network units 110 to 112 and transfers a MAC frame for control with a result of the assignment indicated to the Mux unit 182.

From the Mux unit 182 to the transmission/reception unit 171 of each of the optical network units 110 to 112, the MAC frame for control is transferred according to the above-described method.

The transmission/reception unit 171 of each of the optical network units 110 to 112 transfers the received MAC frame for control to the Demux unit 173. The Demux unit 173 transfers the MAC frame for control to the MAC frame controlling unit 175.

The MAC frame controlling unit 175 of each of the optical network units 110 to 112 outputs frames accumulated in the buffer unit 174 to the transmission/reception unit 171 based on the frame transmission allowed period indicated in the received MAC frame for control.

In the buffer unit 174, frames transferred from the client devices 150 to 152 to the transmission/reception unit 170 and MAC frames for management/control which are generated in the MAC frame controlling unit 175 are stored through the Mux unit 172.

The transmission/reception unit 171 sends the received frames to the fibers 140 to 142.

The sent out frames are converged at the passive signal converging/separating unit 130 without collision, transferred to the transmission/reception unit 180 of the optical line termination 120 through the shared fiber 145, transferred to the transmission/reception unit 181 through the Demux unit and then transferred to the local switch 160. As to MAC frames for management/control, they are separated by the Demux unit 183 and transferred to the MAC frame controlling unit 185.

The above-described conventional techniques have the following shortcomings.

FIG. 20 shows a data string 200 transferred between the optical line termination (server) 120 and the optical network units (communication terminals) 110 to 112 in the above-described EPON system 100.

In the data string 200, main signal data, management information data, control information data and the like are transferred in MAC frames 210 to 212 defined by IEEE 802.3 and to the heads of the MAC frames 210 to 212, 8-byte preambles 220 to 222 are attached.

Here, in even a case where data transferred between the optical line termination 120 and the optical network units 110 to 112 is, for example, data whose amount of information is small such as data indicative of a state of accumulation of the buffer unit 174 of the optical network units 110 to 112 for use in controlling assignment of a frame transmission allowed period (1-bit information indicative of existence/non-existence of a frame), it will be transferred by the MAC frame shown in FIG. 20 (which indicates a case where the MAC frame is a MAC frame 201 for management/control). In this case, real data 201a is 1-bit data indicative of an accumulation state of the buffer unit 174 and the remaining part is padding data 201b.

The MAC frames 210 to 212 are variable-length frames whose minimum size is 64 bytes. When the above-described MAC frame has the real data 201a whose size is smaller than the minimum size such as the MAC frame 201 for management/control, the padding data 201b is inserted to make the total size to be 64 bytes.

As described in the foregoing, the conventional EPON system 100 has the problem that data transfer efficiency is deteriorated because even data whose real data size is smaller than a minimum size is transferred by using a MAC frame.

### SUMMARY OF THE INVENTION

An object of the present invention is to solve the shortcomings of the above-described conventional techniques and provide a communication system, a communication terminal, a server and a data transfer control program which realize data transfer without deterioration in data transfer efficiency.

According to the first aspect of the invention, a communication system for transmitting and receiving variable-length communication frames as a data string between a plurality of communication terminals and a server, wherein

a control frame which is indicative of control information necessary for communication between the communication terminal and the server and whose size is smaller than the size of the communication frame is transferred being included in a preamble portion between respective the communication frames of the data string.

In the preferred construction, the communication terminal or the server generates the control frame to be transferred and multiplexes the frame with the preamble portion to make a data string to be transferred to the server or to the communication terminal.

In another preferred construction, the communication terminal or the server having received the data string with the control frame multiplexed with the preamble portion takes out the control frame in the preamble portion to execute processing according to the contents of the control frame, as well as adding a predetermined bit pattern for preamble to the preamble portion and externally transferring the obtained frames.

In another preferred construction, when the communication frame to be transmitted fails to exist, the control frame is transferred as an independent frame.

In another preferred construction, the control frame includes a kind of frame field indicating that a frame in question is the control frame, an address field indicative of an address of at least either a transmission source unit or a transmission destination unit, and a data field indicative of a kind and contents of the control information.

In another preferred construction, the control frame further includes an error correction field for storing data for error correction.

In another preferred construction, the address field of the control frame transmitted by each the communication terminal to the server has an indication of an address of the communication terminal as a transmission source of the control frame in question and the address field of the control frame transmitted by the server to each the communication terminal has an indication of an address of the communication terminal as a transmission destination of the control frame in question.

In another preferred construction, in the control frame, OAM information or ranging control information is described.

In another preferred construction, the control frame transmitted by the server to each the communication terminal has an indication of the transmission allowed period assigned by the server to the communication terminal in question, and each the communication terminal sequentially transmits the communication frames to the server during a transmission allowed period assigned to each the communication terminal by the server.

In another preferred construction, each the communication terminal notifies the server of information about traffic of the communication terminal in question using the control frame, and the server assigns the transmission allowed period to each the communication terminal based on the notified traffic information of each the communication terminal.

In another preferred construction, the traffic information notified by each the communication terminal to the server includes at least either one of information about an amount of the communication frames accumulated by the communication terminal in question or an amount of the communication frames newly accumulated by the communication terminal in question after transmitting the communication frames to the server last time and information indicating whether the amount of the communication frames accumulated by the communication terminal in question or the amount of the communication frames newly accumulated exceeds a predetermined threshold or not.

In another preferred construction, the traffic information notified by each the communication terminal to the server includes at least either one of information indicative of a maximum value of a waiting time for the communication terminal in question to wait for transmission of the communication frames accumulated and information indicating whether the maximum value of the waiting time exceeds a predetermined threshold value or not.

In another preferred construction, the server designates the transmission allowed period in the control frame transmitted to each the communication terminal by using a start time and an end time of the transmission allowed period in question.

In another preferred construction, the control frame is transferred using a remaining region of the preamble portion excluding the final one byte.

Also, the communication frame is an Ethernet (R) frame.

According to the second aspect of the invention, a communication terminal for transmitting and receiving variable-length communication frames as a data string to and from a server, comprises means for transferring, to the server, a control frame which is indicative of control information necessary for communication with the server and whose size is smaller than the size of the communication frame so as to be included in a preamble portion between respective the communication frames of the data string.

In the preferred construction, the communication terminal generates the control frame to be transferred and multiplexes the frame with the preamble portion to make a data string to be transferred to the server.

In another preferred construction, the communication terminal, when receiving the data string with the control frame multiplexed with the preamble portion, takes out the control frame in the preamble portion to execute processing according to the contents of the control frame, as well as adding a predetermined bit pattern for preamble to the preamble portion and externally transferring the obtained frames.

In another preferred construction, the communication terminal further comprises means for, when the communication frame to be transmitted fails to exist, transferring the control frame as an independent frame to the server.

In another preferred construction, the communication terminal, during the transmission allowed time assigned by the server by using the control frame, sequentially transmits the communication frames to the server.

In another preferred construction, the communication terminal notifies traffic information to the server by using the control frame, and receives the control frame which designates the transmission allowed period assigned based on the traffic information from the server.

In another preferred construction, the communication terminal notifies the server of confirmation information with respect to a request for ranging control indicated in the control frame received from the server by using the control frame to stop transmission of the communication frame to the server according to a request for transmission stop indicated in the control frame received from the server.

In another preferred construction, the communication terminal further comprises means for receiving OAM information of the server from the server by using the control frame and transferring the OAM information to the server by using the control frame.

According to the third aspect of the invention, a server for transmitting and receiving a variable-length communication frame as a data string to and from a communication terminal, comprises means for transferring, to the communication terminal, a control frame which is indicative of control information necessary for communication with the communication terminal and whose size is smaller than the size of the communication frame so as to be included in a preamble portion between respective the communication frames of the data string.

In the preferred construction, the server generates the control frame to be transferred and multiplexes the frame with the preamble portion to make a data string to be transferred to the communication terminal.

In another preferred construction, the server, when receiving the data string with the control frame multiplexed with the preamble portion, takes out the control frame in the preamble portion to execute processing according to the contents of the control frame, as well as adding a predetermined bit pattern for preamble to the preamble portion and externally transferring the obtained frames.

In another-.preferred construction, the server further comprises means for, when the communication frame to be transmitted fails to exist, transferring the control frame as an independent frame to the server.

In another preferred construction, the server further comprises means for, based on traffic information of the communication terminal indicated in the control frame received from the communication terminal in question, assigning the transmission allowed period to the communication terminal in question and notifying the transmission allowed period to the communication terminal in question by using the control frame.

In another preferred construction, the server further comprises means for transmitting a ranging request to the communication terminal whose distance is to be measured at ranging control by using the control frame and receiving confirmation information in response to the ranging control request by using the control frame.

In another preferred construction, the server further comprises means for receiving, from the communication terminal, OAM information of the communication terminal in question by using the control frame and transferring the OAM information to the communication terminal by using the control frame.

According to another aspect of the invention, a frame transmission control program for controlling frame transmission of a communication terminal which transmits and receives variable-length communication frames as a data string to and from a server by controlling a computer, comprising the functions of transferring, to the server, a control frame which is indicative of control information necessary for communication with the server and whose size is smaller than the size of the communication frame so as to be included in a preamble portion between respective the communication frames,

when the communication frame to be transmitted fails to exist, transferring the control frame as an independent frame to the server, and receiving the control frame transferred from the server.

In the preferred construction, he frame transmission control program further comprises the function of generating the control frame to be transferred and multiplexing the frame with the preamble portion to make a data string to be transferred to the server.

In another preferred construction, the frame transmission control program further comprises the functions of

when receiving the data string with the control frame multiplexed with the preamble portion, taking out the control frame of the preamble portion to execute processing according to the contents of the control frame, and

adding a predetermined bit pattern for preamble to the preamble portion and externally transferring the obtained frames.

According to a further aspect of the invention, a frame transmission control program for controlling frame transmission of a server which transmits and receives variable-length communication frames as a data string to and from a communication terminal by controlling a computer, comprises the functions of

transferring, to the communication terminal, a control frame which is indicative of control information necessary for communication with the communication terminal and whose size is smaller than the size of the communication frame so as to be included in a preamble portion between respective the communication frames,

when the communication frame to be transmitted fails to exist, transferring the control frame as an independent frame to the communication terminal, and

receiving the control frame transferred from the communication terminal.

Other objects, features and advantages of the present invention will become clear from the detailed description given herebelow.

### BRIEF DESCRIPTION OF THE DRAWINGS

The present invention will be understood more fully from the detailed description given herebelow and from the accompanying drawings of the preferred embodiment of the invention, which, however, should not be taken to be limitative to the invention, but are for explanation and understanding only.

In the drawings:

FIG. 1 is a structural diagram showing an EPON system according to a first mode of implementation of the present invention;

FIG. 2 is a diagram showing an example of a network system to which the EPON system according to the first mode of implementation is applied;

FIG. 3 is a diagram showing a signal string in the EPON system of the present invention;

FIG. 4 is a diagram showing a short frame for management/control according to the first mode of implementation of the present invention;

FIG. 5 is a flow chart for use in explaining operation of an optical line termination conducted in downstream data transfer which is processing of data transfer by the EPON system according to the first mode of implementation;

FIG. 6 is a flow chart for use in explaining operation of an optical network unit conducted in downstream data transfer which is processing of data transfer by the EPON system according to the first mode of implementation;

FIG. 7 is a flow chart for use in explaining operation of the optical network unit in upstream data transfer which is processing of data transfer by the EPON system according to the first mode of implementation;

FIG. 8 is a flow chart for use in explaining operation of the optical line termination conducted in upstream data transfer which is processing of data transfer by the EPON system according to the first mode of implementation;

FIG. 9 is a diagram showing a data string in a downstream direction in a case where frame sending is controlled using a short frame for management/control according to a first embodiment of the present invention;

FIG. 10 is a diagram showing a short frame for management/control in a case where frame sending is controlled using the short frame for management/control according to the first embodiment of the present invention;

FIG. 11 is a diagram showing a short frame for management/control in a case where frame sending is controlled using the short frame for management/control according to the first embodiment of the -present invention;

FIG. 12 is a diagram showing a short frame for management/control in a case where frame sending is controlled using the short frame for management/control according to the first embodiment of the present invention;

FIG. 13 is a diagram showing a data string in the downstream direction in a case where frame sending is controlled using a short frame for management/control according to a second embodiment of the present invention;

FIG. 14 is a diagram showing a short frame for management/control in a case where frame sending is controlled using the short frame for management/control according to the second embodiment of the present invention;

FIG. 15 is a diagram showing a short frame for management/control in a case where frame sending is controlled using the short frame for management/control according to the second embodiment of the present invention;

FIG. 16 is a diagram showing a short frame for management/control in a case where frame sending is controlled using the short frame for management/control according to the second embodiment of the present invention;

FIG. 17 is a diagram showing a data string in an upstream direction in a case where a frame is sent using a short frame for management/control based on control according to the second embodiment of the present invention;

FIG. 18 is a diagram showing an example of a short frame for management/control which is transferred in frame sending in FIG. 17;

FIG. 19 is a structural diagram showing a conventional EPON system; and

FIG. 20 is a diagram showing a signal string in the conventional EPON system.

### DESCRIPTION OF THE PREFERRED EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

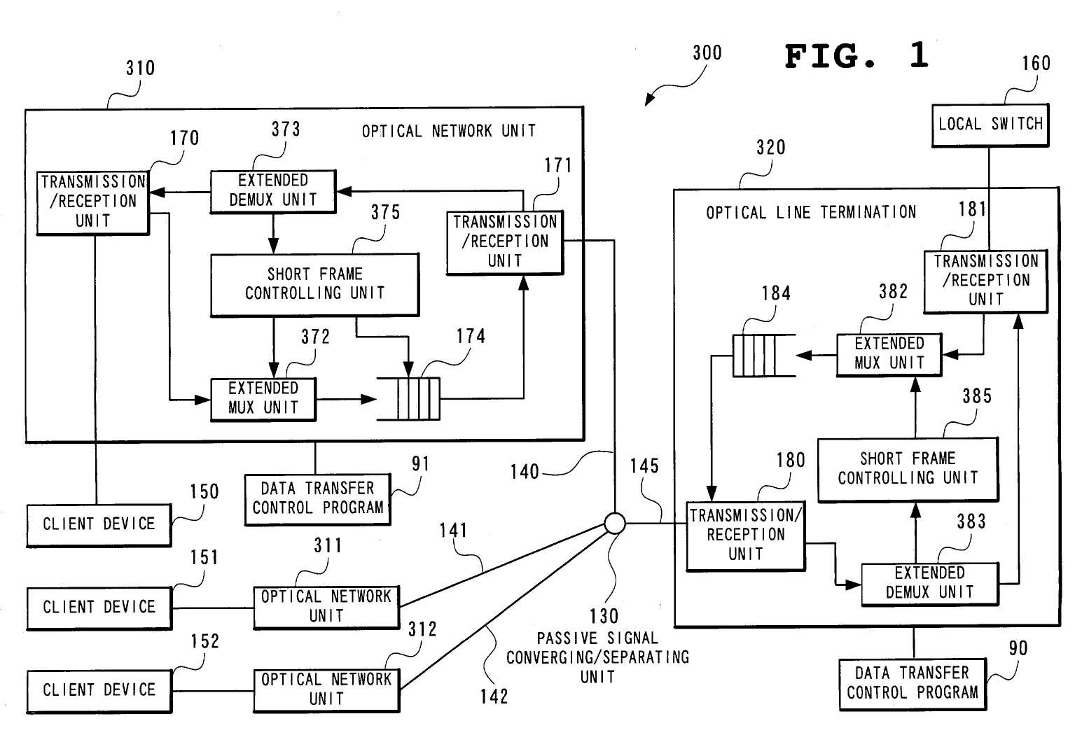

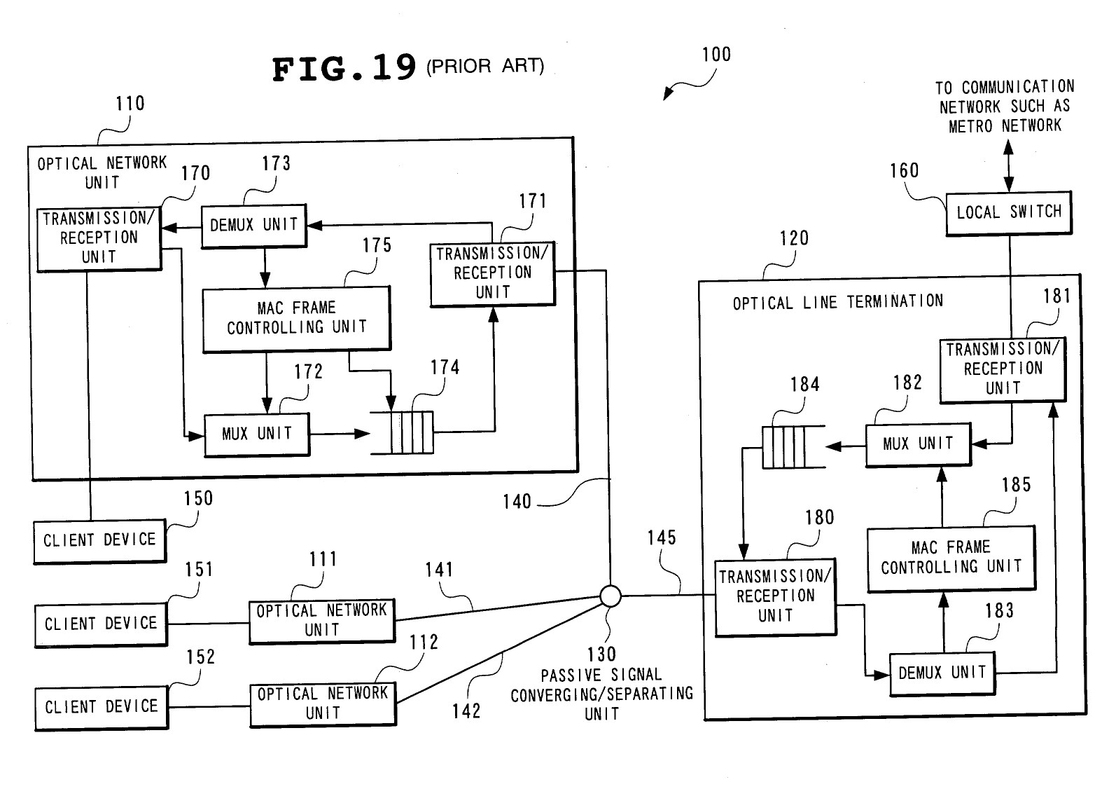

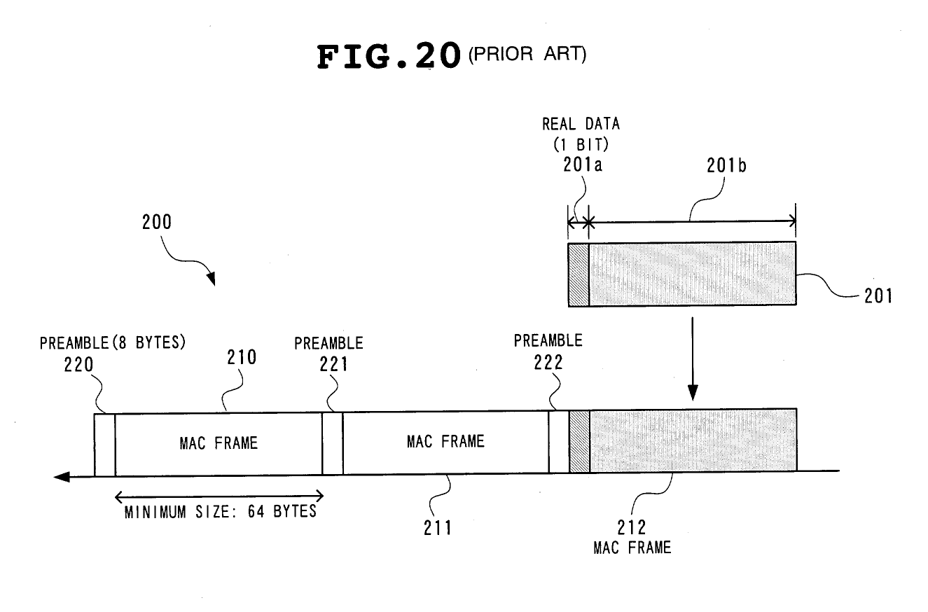

FIG. 1 is a block diagram showing a structure of an EPON system (communication system) 300 according to a first mode of implementation of the present invention. Components having the same functions as those of the counterparts of the EPON system 100 shown in FIG. 19 which illustrates conventional art are given the same reference numerals.

With the EPON system 300 of the present embodiment, in optical network units (communication terminals) 310 to 312, the MAC frame controlling unit 175 of the conventional optical network units 110 to 112 shown in FIG. 19 is replaced by a short frame controlling unit 375 and the Mux unit 172 and the Demux unit 173 are replaced by an extended Mux unit 372 and an extended Demux unit 373. In addition, in an optical line termination (server) 320, the MAC frame controlling unit 185 of the conventional optical line termination 120 is replaced by a short frame controlling unit 385 and the Mux unit 182 and the Demux unit 183 are replaced by an extended Mux unit 382 and an extended Demux unit 383, respectively.

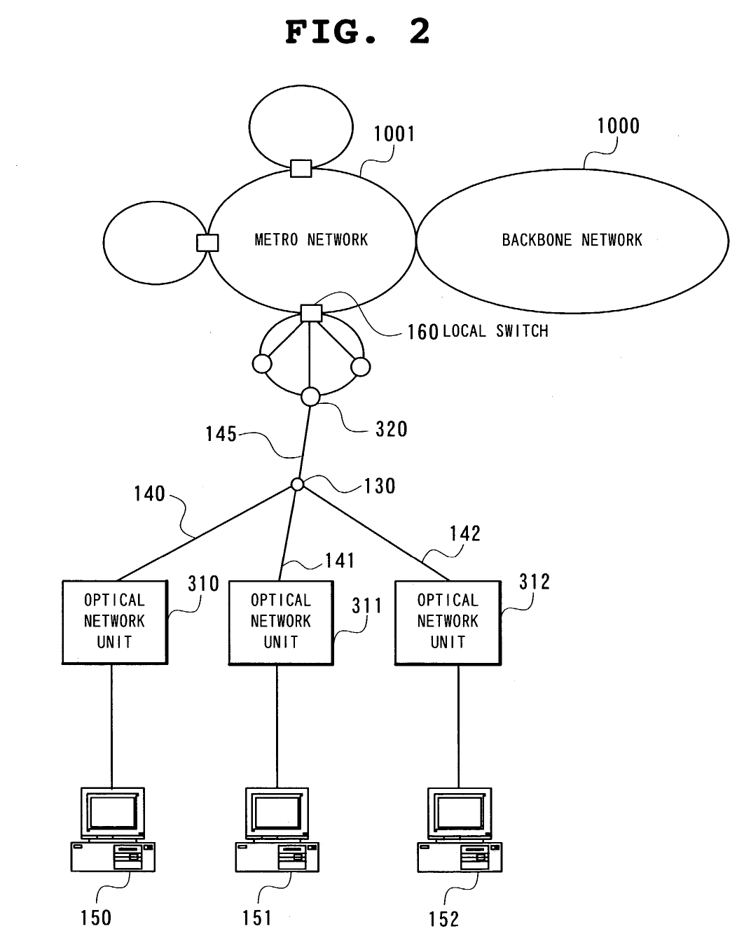

FIG. 2 shows an example of a network system to which the EPON system 300 of the present mode of implementation is applied, in which the EPON system 300 is connected through a local switch 160 to a metro network 1001 connected to a backbone network 1000.

Description will be made of processing of data transfer in the EPON system 300 according to the present mode of implementation having such arrangement.

First, data transfer in a downstream direction (from the optical line termination 320 to the optical network units 310 through 312) will be described.

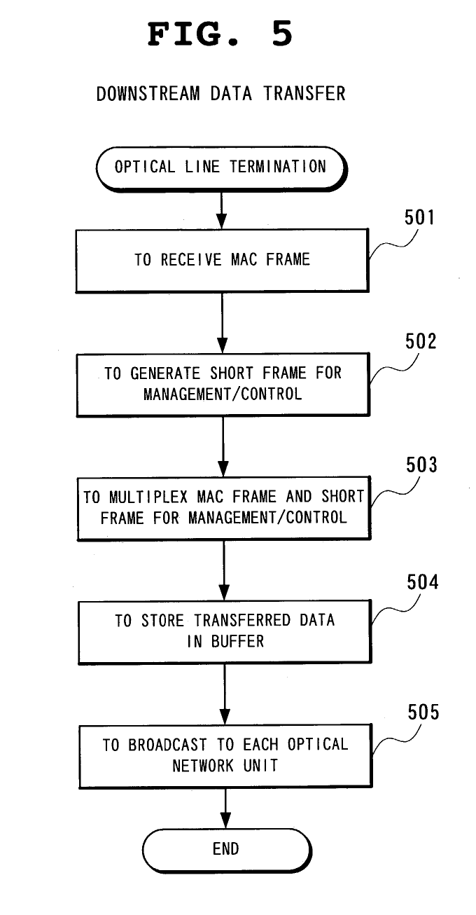

First, operation in the optical line termination 320 will be described with reference to the flow chart of FIG. 5.

Upon receiving a variable-length MAC frame from the local switch 160, the transmission/reception unit 181 of the optical line termination 320 transfers only a MAC frame adapted to address processing to the extended Mux unit 382 (Step 501).

A short frame for management/control which is control information related to each of the optical network units 310 to 312 is generated by the short frame controlling unit 385 as required (Step 502) and to the extended Mux unit 382, the short frame for management/control (control frame) generated by the short frame controlling unit 385 is transferred together with the MAC frame from the transmission/reception unit 181, so that the extended Mux unit 382 multiplexes the MAC frame and the short frame for management/control (control frame) (Step 503).

The short frame for management/control is defined as an interface for transferring management information and control information whose amount is expected to be small. Examples of information transferred in a short frame for management/control include OAM information of the optical line termination 320, information about assignment of an allowed period of frame transmission to the optical network units 310 to 312 and control information for controlling ranging (distance measuring) (e.g. a ranging request to the target optical network units 310 to 312 and a frame transmission stop request to the target optical network units 310 to 312).

While a conventional system transmits these management information/control information by using a common MAC frame whose minimum size is 64 bytes, the system of the present invention transmits the same by using a short frame for management/control whose size is smaller.

Moreover, according to the data transfer method of the present invention, in order to eliminate a bandwidth loss caused by transmission of management information/control information, the short frame for management/control is transferred in a preamble located between the MAC frames. More specifically, the extended Mux unit 382 multiplexes the short frame for management/control transferred from the short frame controlling unit 385 with a preamble located between individual MAC frames transferred from the transmission/reception unit 181.

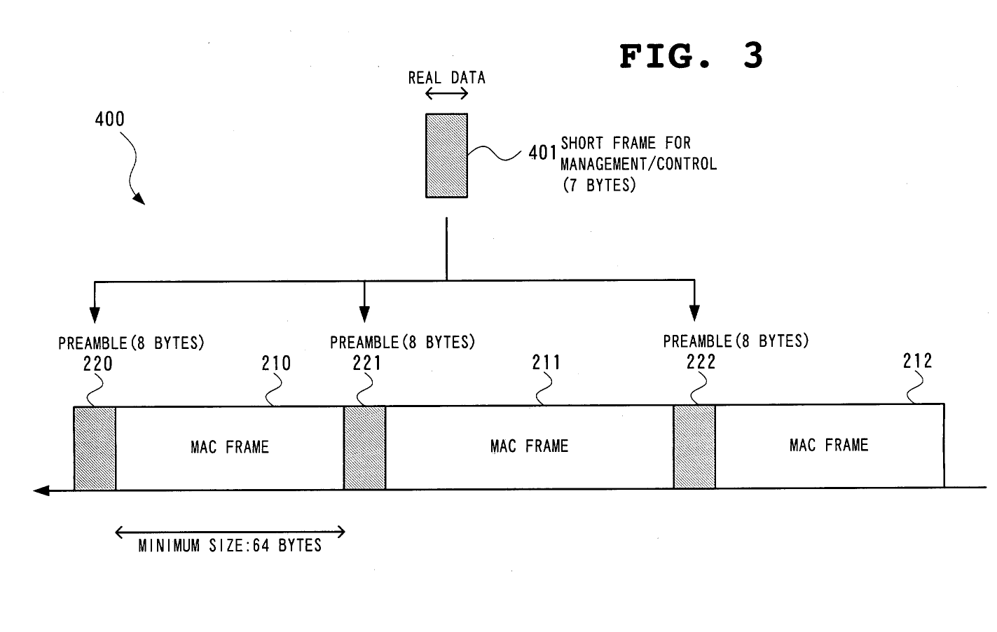

FIG. 3 shows a data string 400 having been multiplexed which is output from the extended Mux unit 382. The data string 400 is composed of the MAC frames 210 to 212 and the preambles 220 to 222.

According to the data transfer method of the present invention, a short frame 401 for management/control information is transferred in the preambles 220 to 222. By thus transferring the short frame 401 for management/control information in the preambles 220 to 222, management/control information can be transferred without consuming a main signal bandwidth, so that deterioration in data transfer efficiency can be suppressed.

When there exists none of the MAC frames 210 to 212 of the main signal to be transmitted at the transmission of the short frame 401 for management/control, however, none of the preambles 220 to 222 exists, whereby the short frame 401 for management/control can not be transmitted. Therefore, when there is none of the MAC frames 210 to 212 to be transmitted, assume that the short frame 401 for management/control is transmitted singly.

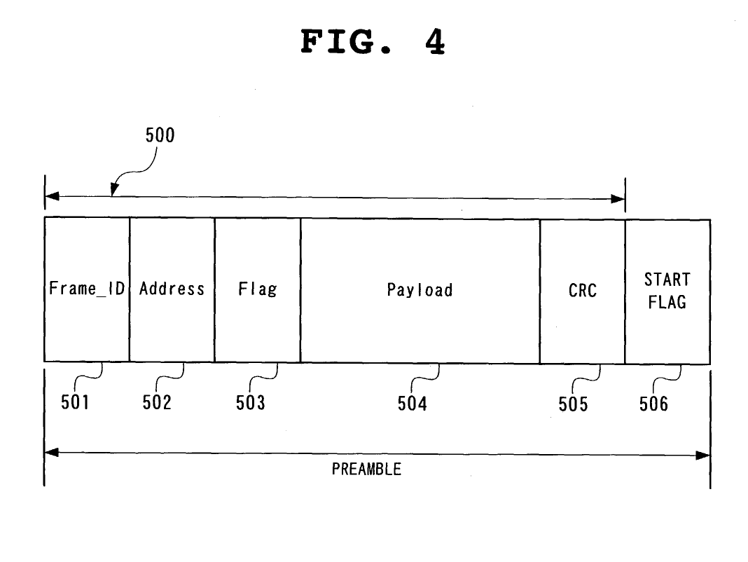

FIG. 4 shows an example of a structure of a short frame 500 for management/control which is generated by the short frame controlling unit 385 of the optical line termination 320 (and the short frame controlling unit 375 of the optical network unit). The short frame 500 for management/control is composed of a Frame_ID field 501, an Address field 502, a Flag field 503, a Payload field 504 and a CRC field 505. The CRC field 505 may be omitted in some cases.

In the Frame_ID field 501, an identifier indicating that a frame to be transferred is the short frame 500 for management/control is described. Also when the short frame 500 for management/control is transmitted not in the preamble but singly, the identifier of the Frame ID field 501 enables the short frame 500 for management/control and a common MAC frame to be distinguished from each other.

It is for example possible to identify a frame to be transferred as being the short frame 500 for management/control by defining a special identifier indicative of the short frame 500 for management/control in the Frame_ID field 501. On the other hand, when a data string transferred in a part of the preamble is a bit pattern of a common preamble (10101010 . . . ), it is identified as being a common MAC frame.

In the Address field 502, the addresses of the optical network units 310 to 312 are indicated. The addresses described in the Address field 502 may be not the MAC addresses of the optical network units 310 to 312 but be unique identifiers unitarily identifying the optical network units 310 to 312 in a line of a network in order to reduce a volume of data.

With the short frame 500 for management/control which is transmitted in downstream data transfer, the identifiers of the optical network units 310 to 312 described in the Address field 502 indicate transmission destination addresses and with the short frame 500 for management/control which is transmitted in upstream data transfer, the identifiers of the optical network units 310 to 312 described in the Address field 502 indicate transmission source addresses.

In the Flag field 503, an identifier indicative of a kind of the short frame 500 for management/control is described. Kinds of frame include a frame for management information and a frame for control information. Expected control information includes information for controlling bandwidth assignment and ranging control. For more minute control, it is desirable to reserve an identifier for extension.

As to the Flag field 503, it can be used also as the Frame_ID field 501. In such a case, from the arrangement of the short frame 500 for management/control, the Flag field 503 is omitted and in the Frame_ID field 501, an identifier indicative of a kind of frame is described.

In the Payload field 504, information corresponding to a kind of frame described in the Flag field 503 is indicated. In the CRC field 505, error correction data of the short frame 500 for management/control is described.

In a case where the above-described short frame 500 for management/control is transferred being multiplexed with the preamble, since it is necessary to reserve the final one bye of the preamble as a start flag 506, the size of the short frame 500 for management/control will be not more than seven bytes. More specifically, the size of the preamble in a case where the short frame 500 for management/control is multiplexed will be, as shown in FIG. 4, eight bytes which is obtained by adding one byte of the start flag 506 to the end of the short frame 500 for management/control structured as described above.

Thus structured short frame 500 for management/control information and MAC frame are multiplexed by the extended Mux unit 382 in a manner as described and transferred to the buffer unit 184 (Step 504). The buffer unit 184 temporarily stores the transferred data and transfers the same to the transmission/reception unit 180. The transmission/reception unit 180 broadcasts the data string to each of the optical network units 310 to 312 (Step 505).

Next, operation at the optical network units 310 to 312 will be described with reference to the flow chart of FIG. 6.

Out of received data strings, the transmission/reception unit 171 of each of the optical network units 310 to 312 transfers only the one whose address agrees to the extended Demux unit 373 (Step 601).

The extended Demux unit 373 takes out the short frame 500 for management/control transferred in the preamble of the received data string by separating the same and transfers the same to the short frame controlling unit 375 (Step 602), as well as adding a bit pattern (10101010 . . . ) of a common preamble to the preamble portion to make the frame be a common MAC frame (Step 603). Then, transfer the common MAC frame to the transmission/reception unit 170. The transmission/reception unit 170 transfers the received MAC frame to each of client devices 150 to 152 (Step 604).

The short frame controlling unit 375 having received the short frame 500 for management/control conducts processing according to the contents of the received short frame 500 for management/control (Step 605).

Subsequently, data transfer in an upstream direction (from the optical network units 310 to 312 to the optical line termination 320) will be described.

Similarly to the conventional techniques, in order to prevent collision of frames sent from the plurality of optical network units 310 to 312 at the passive signal converting/separating unit 130, the optical line termination 320 assigns a frame transmission allowed period to each of the optical network units 310 to 312 and each of the optical network units 310 to 312 sends out a frame according to information about the assignment.

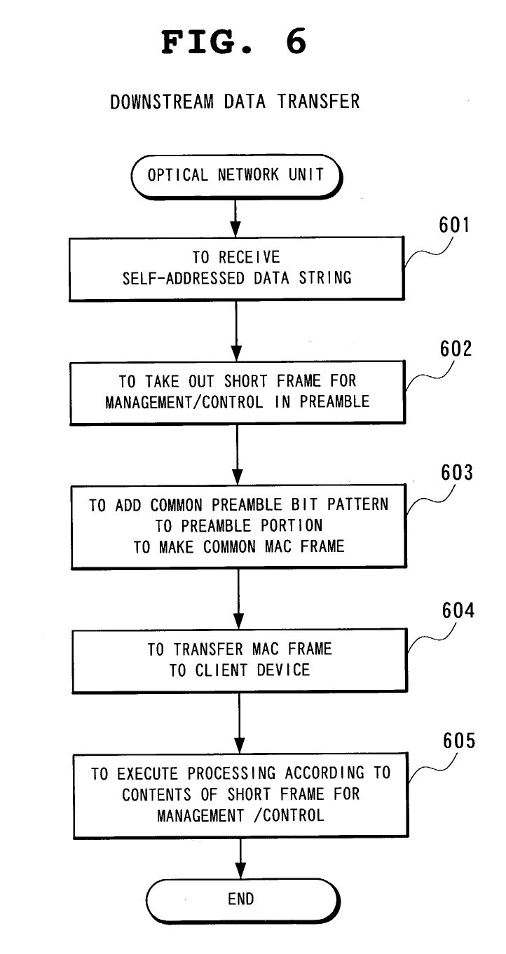

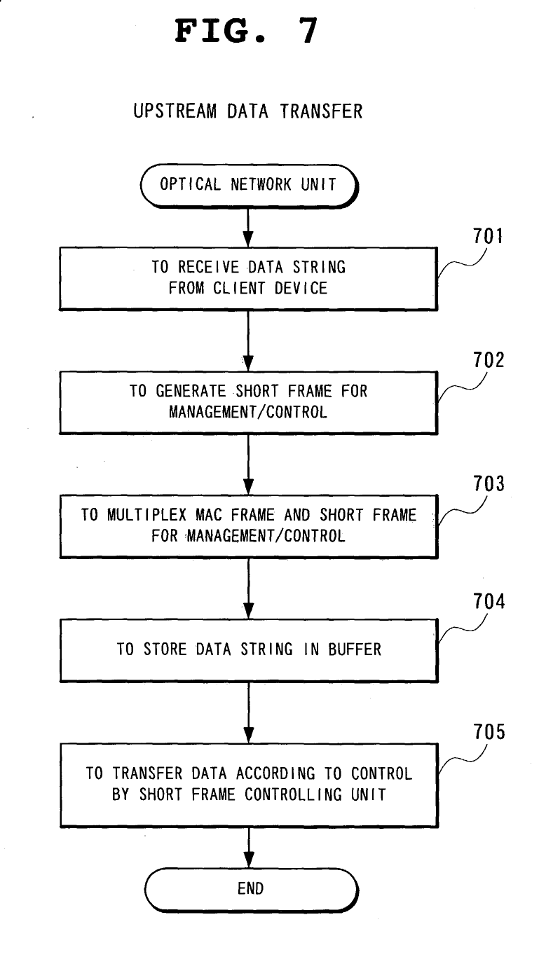

First, operation at the optical network units 310 to 312 will be described with reference to the flow chart of FIG. 7.

Upon receiving the MAC frame from the client devices 150 to 152, the transmission/reception unit 170 of each of the optical network units 310 to 312 conducts address processing and transfers only a MAC frame agreed to the extended Mux unit 372 (Step 701).

When there exists control information to be transmitted to the optical line termination 320, a short frame for management/control is generated by the short frame controlling unit 385 (Step 702) and to the extended Mux unit 372, the short frame 500 for management/control generated at the short frame controlling unit 375 is transferred together with the MAC frame from the transmission/reception unit 170.

Information transferred in the short frame 500 for management/control includes, for example, OAM information of the optical network units 310 to 312, bandwidth assignment request information of the optical network units 310 to 312 for use in assignment calculation of a frame transmission allowed period made at the optical line termination 320 and Ack information in response to a ranging request in ranging control.

The extended Mux unit 372, similarly to a case of a downstream direction, multiplexes the short frame 500 for management/control with the preamble portion between the MAC frames (Step 703) and stores the data string in the buffer unit 174 (Step 704). The buffer unit 174 transfers the stored data string to the transmission/reception unit 171 according to an instruction from the short frame controlling unit 375.

The short frame controlling unit 375, which has received information about a frame transmission allowed period sent from the optical line termination 320, instructs the buffer unit 174 on data output during the period allowed for frame transmission.

The transmission/reception unit 171 having received the data string from the buffer unit 174 transfers the data string to the fiber 140. The data string sent to the fiber 140 is transferred to the transmission/reception unit 180 of the optical line termination 320 through the passive signal converging/separating unit 130 and the shared fiber 145 (Step 705).

Next, operation of the optical line termination 320 will be described with reference to the flow chart of FIG. 8.

The transmission/reception unit 180 transfers the data string received from the optical network units 310 to 312 to the extended Demux unit 383 (Step 801).

The extended Demux unit 383 takes out the short frame 500 for management/control transferred in the preamble of the received data string by separating the same and transfers the taken out frame to the short frame controlling unit 385 (Step 802), as well as adding the bit pattern of the original preamble to the preamble in which the short frame 500 for management/control is transferred to make the frame be a common MAC frame (Step 803). Then, transmit the common MAC frame to the transmission/reception unit 181. The transmission/reception unit 181 transfers the frame to the local switch 160 (Step 804).

The short frame controlling unit 385 conducts processing according to the short frame 500 for management/control (Step 805).

As described in the foregoing, the present mode of implementation enables transmission of a short frame for management/control information for transferring management information and control information with the short frame placed in a preamble located between MAC frames or enables transmission of the same singly when there is no preamble. As a result, efficient data transfer can be realized without consuming a main signal bandwidth in transferring management information and control information.

Next, embodiments of the present mode of implementation will be described. First, in a first embodiment, description will be made of a system using a short frame for management/control in the control of assignment of a period allowed to transmit a frame to each of the optical network units 310 to 312 conducted by the optical line termination 320.

Here, out of assignment control requiring a notification of a status from the optical network units 310 to 312 and assignment control requiring no status notification, the assignment control requiring status notification having higher efficiency will be described. In -status notification type assignment control, the optical network units 310 to 312 notify the optical line termination 320 of a status such as a buffer accumulation condition, and the optical line termination 320 assigns a transmission allowed period to each of the optical network units 310 to 312 based on the notified information and notifies the result.

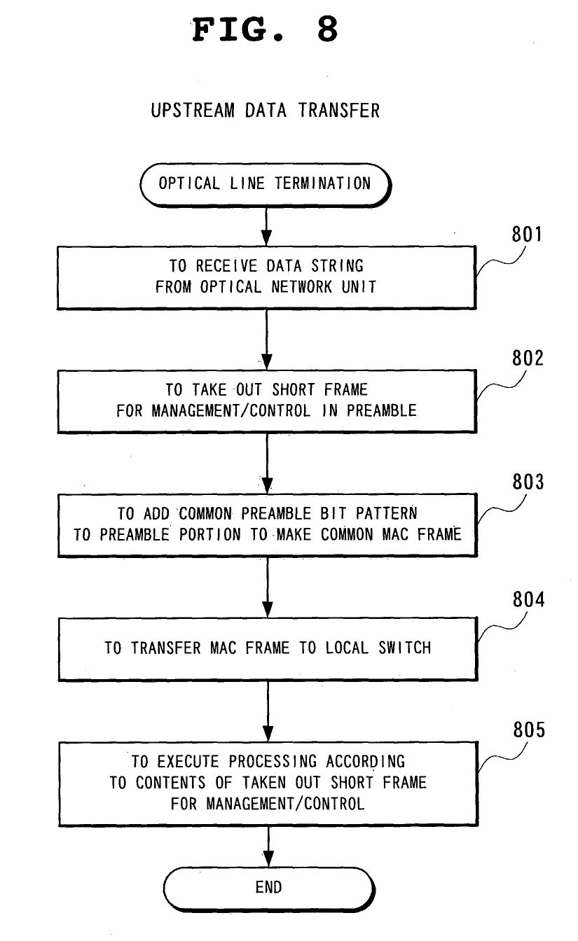

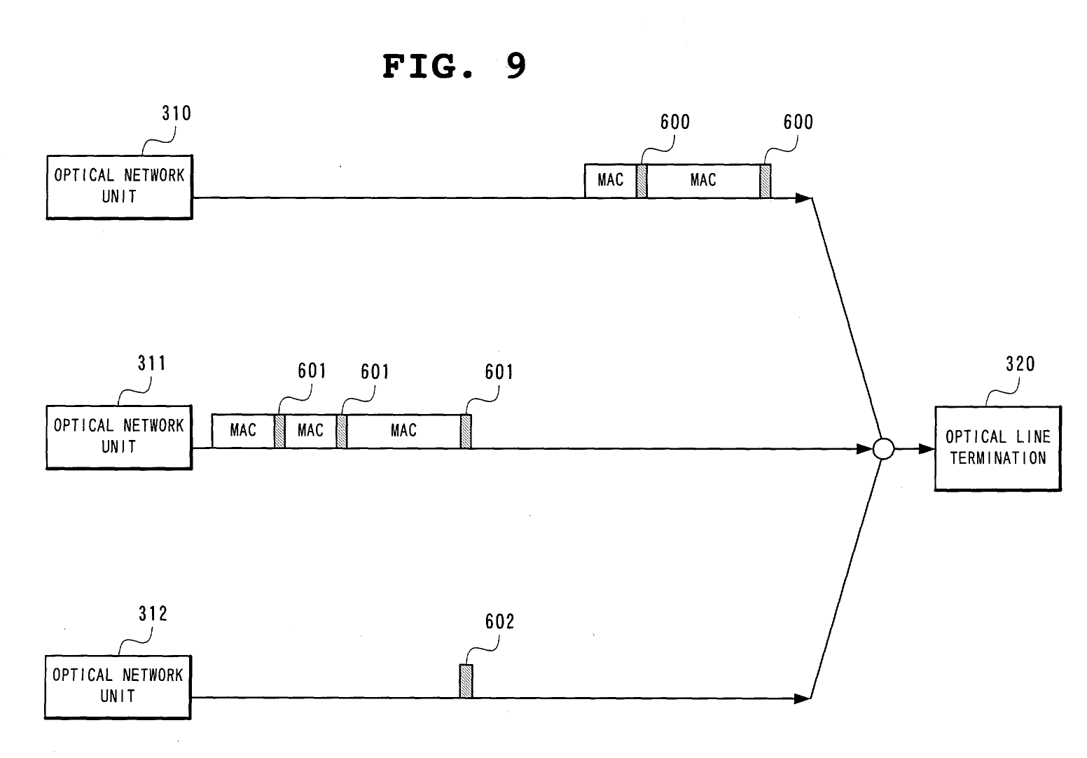

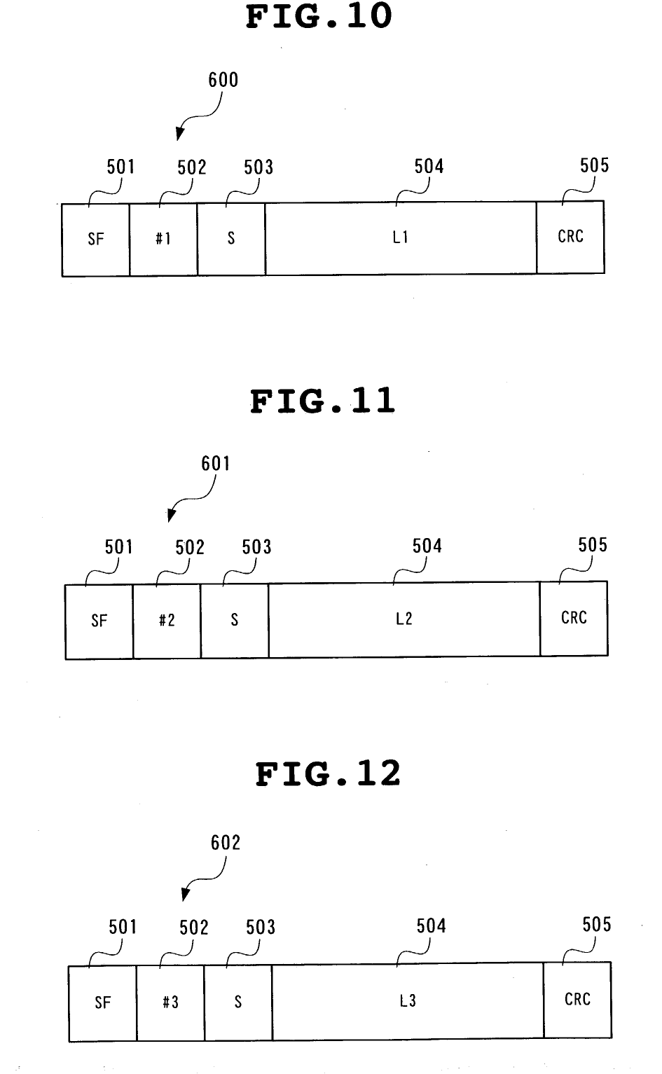

FIGS. 9 to 12 show a data string (FIG. 9) and short frames 600 to 602 for management/control (FIGS. 10 to 12) at the time of status notification from the optical network units 310 to 312 to the optical line termination 320.

Here, a status notified from the optical network units 310 to 312 to the optical line termination 320 is assumed to be an amount of accumulated frames in the buffer. In FIGS. 9 to 12, address identifies of the optical network units 310 to 312 are #1, #2 and #3, respectively, and the amounts of accumulated frames are L1, L2 and L3, respectively.

In FIG. 9, the optical network units 310 and 311 notify the short frames 600 and 601 for management/control using the preamble-located between the MAC frames.

In addition, since no MAC frame to be transferred exists in the optical network unit 312, the unit transfers the short frame 602 for management/control singly.

In the short frame 600 for management/control, the Frame_ID field 501 has an indication of an identifier indicative of a short frame (SF (Short Frame) in this case), the Address field 502 has an indication of the address identifier #1 of the optical network unit 310 as a transmission source, the Flag field 503 has an indication of an identifier indicating that the present short frame is for status notification (S (Status report) in this case), the Payload field 504 has an indication of the amount of accumulated frames L1 which is a status to be notified by the present short frame and the CRC field 505 has an indication of data for error correction.

In each of the short frames 601 and 602 for management/control, the Frame_ID field 501 has an indication of SF, the Address field 502 has that of the address identifier #2, #3, the Flag field 503 has that of an identifier S indicative of status notification, the Payload field 504 has that of the amount of accumulated frame L2, L3 and the CRC field 505 has that of the data for error correction.

The optical line termination 320 having received the short frame 600 for management/control recognizes that the received frame is a short frame according to the Frame_ID field 501, that the transmission source unit is the optical network unit 310 according to the Address field 502, that the short frame is a short frame for status notification according to the Flag field 503 and that the amount of accumulated frames is L1 according to the Payload field 504. This is also the case with the short frames 601 and 602 for management/control.

Each of the optical network units 310 to 312 transmits a plurality of short frames 600 to 602 for management/control in one case and transmits one of them in another case as shown in FIG. 9, and in either case, the optical line termination 320 reflects the latest information among them.

The optical line termination 320 having received the short frames 600 to 602 for management/control assigns a frame transmission allowed period to the optical network units 310 to 312 based on the notified amounts of accumulated frames L1, L2 and L3.

As a result, in the present embodiment, assign a period T1 from time t0 to t1 to the optical network unit 310, a period T2 from time t1 to t2 to the optical network unit 311 and a period T3 from time t2 to t3 to the optical network unit 312.

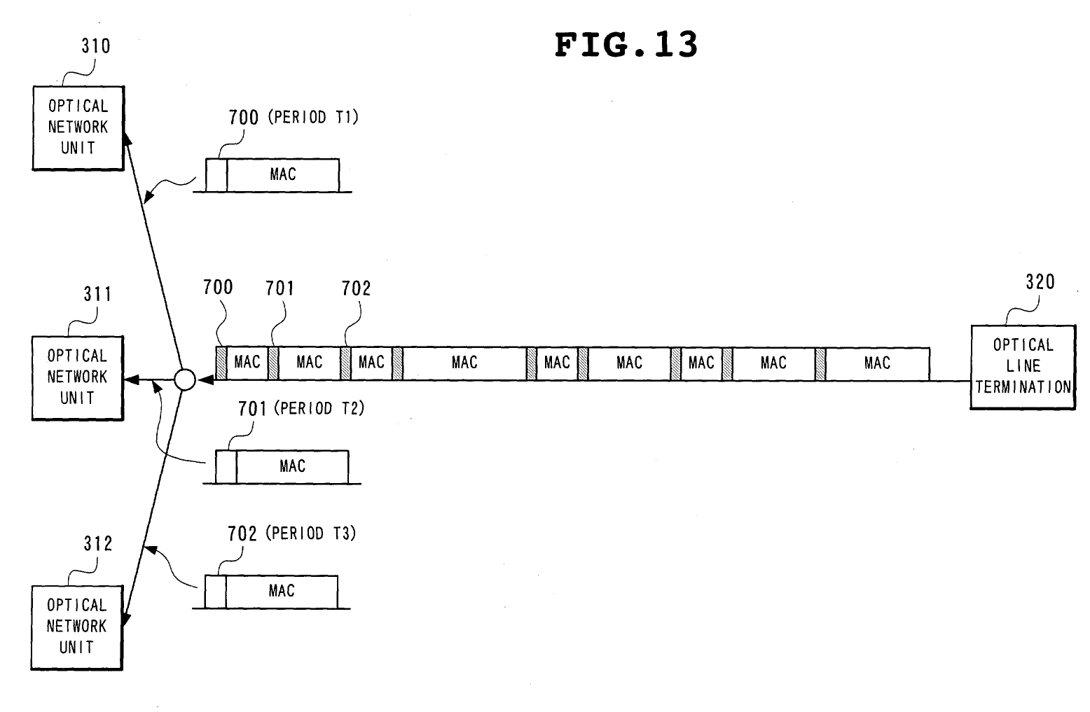

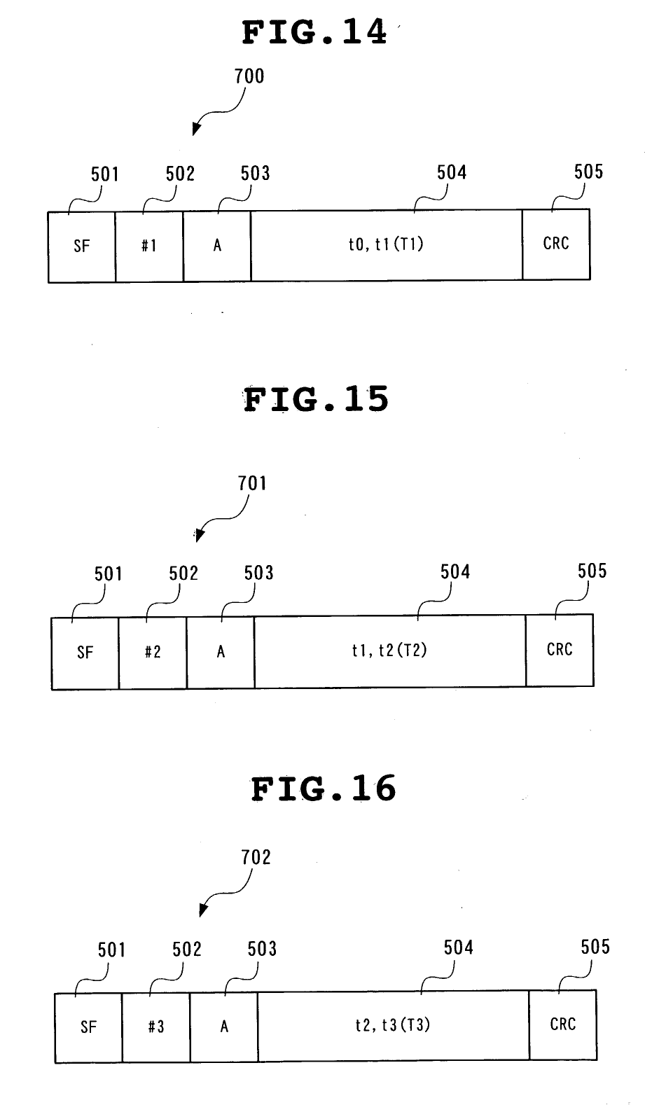

Next, a second embodiment of the present invention will be described. FIGS. 13 to 16 show a data string (FIG. 13) and short frames 700 to 702 for management/control (FIGS. 14 to 16) at the time of notification of assignment information to the optical network units 310 to 312 conducted by the optical line termination 320 according to the present embodiment.

The short frames 700 to 702 for management/control are transferred to each of the optical network units 310 to 312 in a preamble portion located between MAC frames broadcast from the optical line termination 320.

In the short frame 700 for management/control, the Frame_ID field 501 has an indication of an identifier indicative of a short frame (SF (Short Frame) in this case), the Address field 502 has an indication of the address identifier #1 of the optical network unit 310 as a transmission destination, the Flag field 503 has an indication of an identifier indicating that the present short frame is for notification of an assigned bandwidth (A (Assigned bandwidth) in this case), the Payload field 504 has an indication of start time t0 and end time t1 of a transmission allowed period for the optical network unit 310 and the CRC field 505 has an indication of data for error correction.

In each of the short frames 701 and 702 for management/control, the Frame_ID field 501 has an indication-of SF, the Address field 502 has that of the address identifier #2, #3, the Flag field 503 has that of the identifier A indicative of assigned bandwidth notification, the Payload field 504 has that of time from t1 to t2, from t2 to t3 and the CRC field 505 has that of the data for error correction.

Among the optical network units 310 to 312 having received the short frame 700 for management/control, the optical network unit 310 whose identifier is indicated in the Address field 502 recognizes that the received frame is a short frame according to the Frame_ID field 501, that the short frame is a short frame for the notification of an assigned bandwidth according to the Flag field 503 and that a period allowed to transmit frames is from time t0 to t1 according to the Payload field 504. This is also the case with the short frames 701 and 702 for management/control.

The optical network units 310 to 312 having received such short frames 700 to 702 for management/control are allowed to transmit frames from time t0 to time t1 (or from time t1 to time t2, or from time t2 to time t3).

The optical line termination 320 sends out the short frames 700 to 702 for management/control such that they reach the optical network units 310 to 312 before the start time indicated in the Payload field 504.

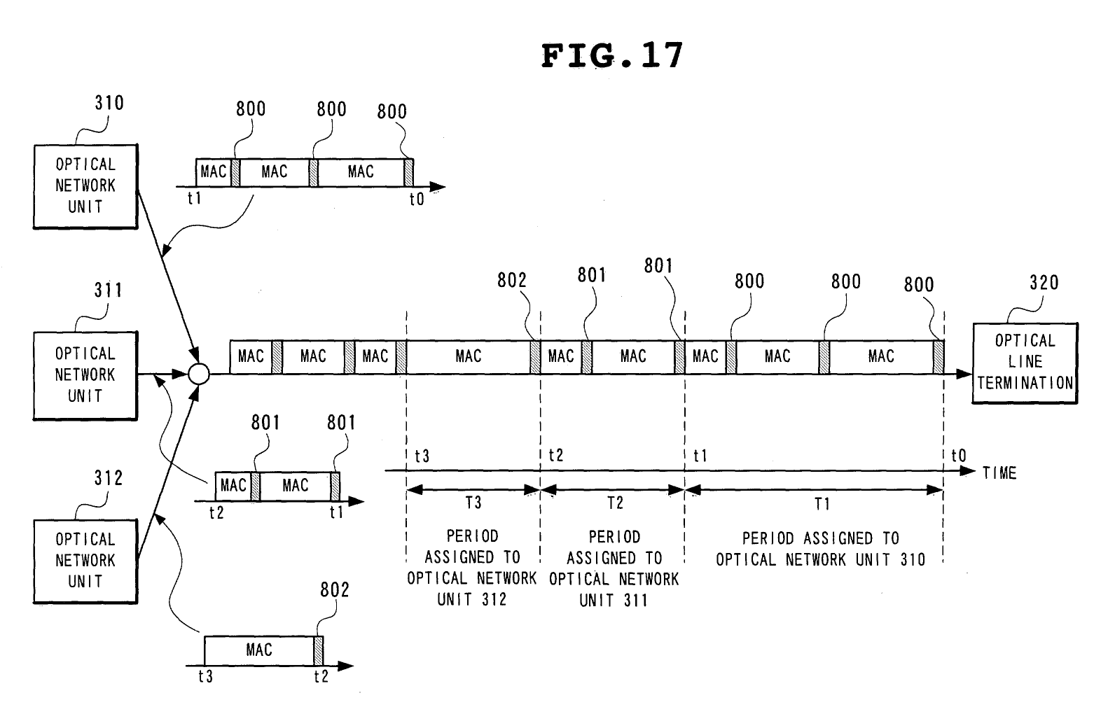

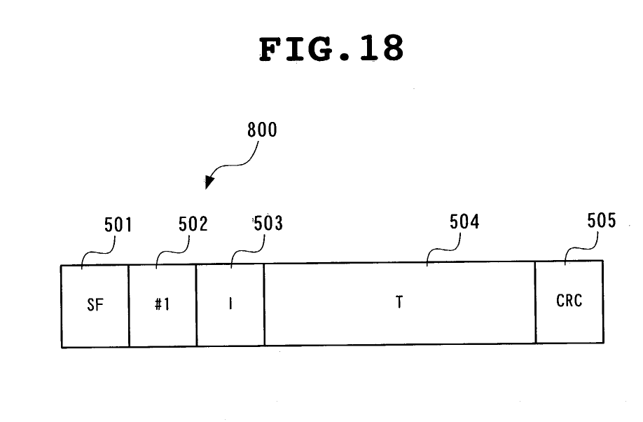

Next, FIGS. 17 and 18 show a case where data is transferred to the optical line termination 320 according to a period allowed for the optical network units 310 to 312 by an assignment information notification according to the second embodiment. In each of short frames 800 to 802 for management/control shown in FIG. 17, the Payload field 504 has an indication of control information from each of the optical network units 310 to 312. For example, as shown in FIG. 18, in the short frame 800 for management/control transmitted from the optical network unit 310, the Flag field 503 has an indication of an identifier I requesting inhibition of frame transmission to the optical network unit 310 and the Payload field 504 has an indication of a period T in which frame transmission is inhibited.

In the period T1 from time t0 to time t1 which is a period assigned to the optical network unit 310, a MAC frame with the short frame 800 for management/control from the optical network unit 310 multiplexed with its preamble portion is transmitted. In addition, in the period T2 from time t1 to time t2 which is a period assigned to the optical network unit 311, a MAC frame with the short frame 801 for management/control from the optical network unit 311 multiplexed with its preamble portion is transmitted, and in the period T3 from time t2 to time 3 which is a period assigned to the optical network unit 312, a MAC frame with the short frame 802 for management/control from the optical network unit 312 multiplexed with its preamble portion is transmitted.

As described in the foregoing, among the optical network units 310 to 312 having received the short frames 700 to 702 for management/control according to the second embodiment, only the optical network unit indicated in the Address field 502 is allowed to send a frame to the optical line termination 320 during the transmission allowed period T1, T2, T3 indicated in the Payload field 504 (the optical network unit which is not indicated in the Address field 502 refrains from sending a frame).

In addition, the short frames 700 to 702 for management/control notified by the optical line termination 320 are successively transmitted to the optical network units 310 to 312 in the plural in one case and transmitted only once when an assigned period changes in another case, and the optical network units 310 to 312 having received the frames reflects the latest information among them.

As described in the foregoing, according to the present embodiment, status of the optical network units 310 to 312 and information about assignment to the optical network units 310 to 312 are notified using the short frames 600 to 602 (or 700 to 702 or 800 to 802) for management/control in a preamble or singly when no preamble exists. As a result, no main signal bandwidth is consumed for notifying status and assignment information, so that efficient data transfer can be realized.

In the EPON system of the present embodiment, the functions of the extended Mux units 372 and 382, the extended Demux units 373 and 383 and the short frame controlling units 375 and 385 in the optical network units 310, 311 and 312 and the optical line termination 320 and other functions can be realized not only by hardware but also by loading a data transfer control program 90 which is a computer program having the respective functions into a memory of a computer processing device. The data transfer control program 90 is stored in a magnetic disc, a semiconductor memory or other recording medium. Then, loading the program from the recording medium into the computer processing device to control operation of the computer processing device realizes the above-described respective functions.

Although the present invention has been described in the foregoing with respect to the preferred modes of implementation and embodiments, the present invention is not necessarily limited to the above-described modes of implementation and embodiments but be realized in variations within its technical idea.

As described in the foregoing, according to the present invention, since no main signal bandwidth is consumed for notifying management information/control information, efficient data transfer can be realized.

More specifically, in the data transfer method of the present invention and a one-to-multimedia sharing type communication system using the same, with a short frame for management/control having a small size defined as an interface for notifying upstream direction or downstream direction management information/control information, the frame is transmitted in a preamble located between common MAC frames or singly when no preamble exists. As a result, no bandwidth for a main signal is consumed in order to notify management information/control information, so that efficient data transfer is enabled.

The present invention thus provides a communication system, a communication terminal, a server and a data transfer control program realizing efficient data transfer.

Although the invention has been illustrated and described with respect to exemplary embodiment thereof, it should be understood by those skilled in the art that the foregoing and various other changes, omissions and additions may be made therein and thereto, without departing from the spirit and scope of the present invention. Therefore, the present invention should not be understood as limited to the specific embodiment set out above but to include all possible embodiments which can be embodies within a scope encompassed and equivalents thereof with respect to the feature set out in the appended claims.

In the claims:

1. A communication system for transmitting and receiving variable-length communication frames as a data string between a plurality of communication terminals and a server, wherein
a control frame which is indicative of control information necessary for communication between said communication terminal and said server and whose size is smaller than the size of said communication frame is transferred being included in a preamble portion between respective said communication frames of said data string.

2. The communication system as set forth in claim 1, wherein
said communication terminal or said server generates said control frame to be transferred and multiplexes the frame with said preamble portion to make a data string to be transferred to said server or to said communication terminal.

3. The communication system as set forth in claim 2, wherein
said communication terminal or said server having received said data string with said control frame multiplexed with said preamble portion
takes out said control frame in said preamble portion to execute processing according to the contents of said control frame, as well as adding a predetermined bit pattern for preamble to said preamble portion and externally transferring the obtained frames.

4. The communication system as set forth in claim 1, wherein
when said communication frame to be transmitted fails to exist, said control frame is transferred as an independent frame.

5. The communication system as set forth in claim 1, wherein
said control frame including
a kind of frame field indicating that a frame in question is said control frame,
an address field indicative of an address of at least either a transmission source unit or a transmission destination unit, and
a data field indicative of a kind and contents of said control information.

6. The communication system as set forth in claim 5, wherein
said control frame further includes an error correction field for storing data for error correction.

7. The communication system as set forth in claim 5, wherein
said address field of said control frame transmitted by each said communication terminal to said server has an indication of an address of said communication terminal as a transmission source of the control frame in question and said address field of said control frame transmitted by said server to each said communication terminal has an indication of an address of said communication terminal as a transmission destination of the control frame in question.

8. The communication system as set forth in claim 1, wherein
in said control frame, OAM information or ranging control information is described.

9. The communication system as set forth in claim 1, wherein
said control frame transmitted by said server to each said communication terminal has an indication of said transmission allowed period assigned by said server to the communication terminal in question, and
each said communication terminal sequentially transmits said communication frames to said server during a transmission allowed period assigned to each said communication terminal by said server.

10. The communication system as set forth in claim 9, wherein
each said communication terminal notifies said server of information about traffic of the communication terminal in question using said control frame, and
said server assigns said transmission allowed period to each said communication terminal based on the notified traffic information of each said communication terminal.

11. The communication system as set forth in claim 10, wherein
said traffic information notified by each said communication terminal to said server includes at least either one of information about an amount of said communication frames accumulated by the communication terminal in question or an amount of said communication frames newly accumulated by the communication terminal in question after transmitting said communication frames to said server last time and information indicating whether the amount of said communication frames accumulated by the communication terminal in question or the amount of said communication frames newly accumulated exceeds a predetermined threshold or not.

12. The communication system as set forth in claim 10, wherein
said traffic information notified by each said communication terminal to said server includes at least either one of information indicative of a maximum value of a waiting time for the communication terminal in question to wait for transmission of said communication frames accumulated and information indicating whether said maximum value of the waiting time exceeds a predetermined threshold value or not.

13. The communication system as set forth in claim 9, wherein
said server designates said transmission allowed period in said control frame transmitted to each said communication terminal by using a start time and an end time of the transmission allowed period in question.

14. The communication system as set forth in claim 1, wherein
said control frame is transferred using a remaining region of said preamble portion excluding the final one byte.

15. The communication system as set forth in claim 1, wherein
said communication frame is an Ethernet (R) frame.

16. A communication terminal for transmitting and receiving variable-length communication frames as a data string to and from a server, comprising
means for transferring, to said server, a control frame which is indicative of control information necessary for communication with said server and whose size is smaller than the size of said communication frame so as to be included in a preamble portion between respective said communication frames of said data string.

17. The communication terminal as set forth in claim 16, which
generates said control frame to be transferred and multiplexes the frame with said preamble portion to make a data string to be transferred to said server.

18. The communication terminal as set forth in claim 17, which,
when receiving said data string with said control frame multiplexed with said preamble portion, takes out said control frame in said preamble portion to execute processing according to the contents of said control frame, as well as adding a predetermined bit pattern for preamble to said preamble portion and externally transferring the obtained frames.

19. The communication terminal as set forth in claim 16, further comprising
means for, when said communication frame to be transmitted fails to exist, transferring said control frame as an independent frame to said server.

20. The communication terminal as set forth in claim 16, which,
during said transmission allowed time assigned by said server by using said control frame, sequentially transmits said communication frames to said server.

21. The communication terminal as set forth in 20, which
notifies traffic information to said server by using said control frame, and
receives said control frame which designates said transmission allowed period assigned based on said traffic information from said server.

22. The communication terminal as set forth in claim 16, which
notifies said server of confirmation information with respect to a request for ranging control indicated in said control frame received from said server by using said control frame to stop transmission of said communication frame to said server according to a request for transmission stop indicated in said control frame received from said server.

23. The communication terminal as set forth in claim 16, further comprising
means for receiving OAM information of said server from said server by using said control frame and transferring the OAM information to said server by using said control frame.

24. A server for transmitting and receiving a variable-length communication frame as a data string to and from a communication terminal, comprising
means for transferring, to said communication terminal, a control frame which is indicative of control information necessary for communication with said communication terminal and whose size is smaller than the size of said communication frame so as to be included in a preamble portion between respective said communication frames of said data string.

25. The server as set forth in claim 24, which
generates said control frame to be transferred and multiplexes the frame with said preamble portion to make a data string to be transferred to said communication terminal.

26. The server as set forth in claim 25, which,
when receiving said data string with said control frame multiplexed with said preamble portion, takes out said control frame in said preamble portion to execute processing according to the contents of said control frame, as well as adding a predetermined bit pattern for preamble to said preamble portion and externally transferring the obtained frames.

27. The server as set forth in claim 24, further comprising
means for, when said communication frame to be transmitted fails to exist, transferring said control frame as an independent frame to said server.

28. The server as set forth in claim 24, further comprising
means for, based on traffic information of said communication terminal indicated in said control frame received from the communication terminal in question, assigning said transmission allowed period to the communication terminal in question and notifying said transmission allowed period to the communication terminal in question by using said control frame.

29. The server as set forth in claim 24, further comprising
means for transmitting a ranging request to said communication terminal whose distance is to be measured at ranging control by using said control frame and receiving confirmation information in response to said ranging control request by using said control frame.

30. The server as set forth in claim 24, further comprising
means for receiving, from said communication terminal, OAM information of the communication terminal in question by using said control frame and transferring the OAM information to said communication terminal by using said control frame.

31. A frame transmission control program for controlling frame transmission of a communication terminal which transmits and receives variable-length communication frames as a data string to and from a server by controlling a computer, comprising the functions of:
transferring, to said server, a control frame which is indicative of control information necessary for communication with said server and whose size is smaller than the size of said communication frame so as to be included in a preamble portion between respective said communication frames,
when said communication frame to be transmitted fails to exist, transferring said control frame as an independent frame to said server, and
receiving said control frame transferred from said server.

32. The frame transmission control program as set forth in claim 31, further comprising
the function of generating said control frame to be transferred and multiplexing the frame with said preamble portion to make a data string to be transferred to said server.

33. The frame transmission control program as set forth in claim 32, further comprising the functions of
when receiving said data string with said control frame multiplexed with said preamble portion, taking out said control frame of said preamble portion to execute processing according to the contents of said control frame, and
adding a predetermined bit pattern for preamble to said preamble portion and externally transferring the obtained frames.

34. A frame transmission control program for controlling frame transmission of a server which transmits and receives variable-length communication frames as a data string to and from a communication terminal by controlling a computer, comprising the functions of:
transferring, to said communication terminal, a control frame which is indicative of control information necessary for communication with said communication terminal and whose size is smaller than the size of said communication frame so as to be included in a preamble portion between respective said communication frames,
when said communication frame to be transmitted fails to exist, transferring said control frame as an independent frame to said communication terminal, and
receiving said control frame transferred from said communication terminal.

35. The frame transmission control program as set forth in claim 34, further comprising
the function of generating said control frame to be transferred and multiplexing the frame with said preamble portion to make a data string to be transferred to said communication terminal.

36. The frame transmission control program as set forth in claim 35, further comprising the functions of
when receiving said data string with said control frame multiplexed with said preamble portion, taking out said control frame of said preamble portion to execute processing according to the contents of said control frame, and
adding a predetermined bit pattern for preamble to said preamble portion and externally transferring the obtained frames.
